(19) United States
(12) Patent Application Publication
(10) Pub. No.: US 2004/0235540 A1
(43) Pub. Date: Nov. 25, 2004

(54) Portable terminal unit

(75) Inventor: Takayuki Yajima, Kanagawa (JP)

Correspondence Address: SCHULTE ROTH & ZABEL LLP, ATTN: JOEL E. LUTZKER, 919 THIRD AVENUE, NEW YORK, NY, 10022, US

(73) Assignee: Kyocera Corporation, Kyoto-shi (JP)

(21) Appl. No.: 10/695,840

(22) Filed: Oct. 29, 2003

(30) Foreign Application Priority Data
Oct. 29, 2002 (JP) P.2002-314837

(51) Int. Cl. H04M 1/00; H04B 1/38

(52) U.S. Cl. 455/575.3; 455/566

(57) ABSTRACT

When a portable terminal unit in which a display-side housing and an operation-side housing are openably and closably coupled is in a closed state, a state detecting section detects that the portable terminal unit is in the closed state, and transmits its signal to a control section. Then, a lock control section validates the operation of the auxiliary operation section. Thereafter, when a coupling section that couples a display-side housing and an operation-side housing turns, the state detecting section detects that the portable terminal unit is in other states than the closed state, and sends its signal to the control section. Then, the lock control section invalidates the operation of the auxiliary operation section which is provided on other surface than surfaces opposed each other in the closed state, so that it is prevented from causing the erroneous operation.

### BACKGROUND OF THE INVENTION

1. Field of the Invention

The present invention relates to a portable terminal unit such as a mobile telephone or a PDA (Personal Digital Assistant), and specifically to a portable terminal unit having such a structure that a display-side housing having at least a display section and an operation-side housing having at least an operation section are coupled each other openably and closably, and the display section is exposed outside in both of the closed state and the opened state.

2. Description of the Related Art

As the conventional portable terminal unit such as a mobile telephone or a PAD, there is one having two housings, which is carried with the two housings superimposed. For example, in JP-A-2002-135380, a portable terminal unit is disclosed, which includes a display-side housing having a display section and a speaker, and an operation-side housing having a main operation section and a microphone, in which the both housings are coupled so that the main operation section can be opened or closed by the display-side housing, and the display section is always exposed to the outside in any of the opened state and the closed state. Further, this portable terminal unit includes an auxiliary operation section on the surface having the display section, when the portable terminal unit is a closed state, applications such as an E-mail and an electronic notebook are started by this auxiliary operation section, and they can be displayed in the display section.

However, the portable terminal unit disclosed in JP-A-2002-158758 has the following problems. When a user brings the portable terminal unit in a opened state for a call so that a speaker is closed to his ear and a microphone is closed to his mouth, the auxiliary operation section comes into contact with his face. At that time, another application may start, and the user's call may be cut off during a call in some cases.

Further, it is thought the auxiliary operation section is provided on a side surface of the display-side housing or the operation-side housing. However, in this case, when the user holds the operation-side housing with his hand for a call in the opened state, his hand comes into contact with the auxiliary operation section, so that such an error operation such as another application starts may be caused.

Further, in any case, when the user changes the opened state to the closed state and when he changes the closed state to the opened state, he holds the display-side housing with his hand different from his hand holding the operation-side housing to open or close the housings. At this opening or closing time, the user presses erroneously the auxiliary operation section, so that the erroneous operation may be caused.

### SUMMARY OF THE INVENTION

The invention provides a portable terminal unit having: a first housing having at least a main operation section; a second housing having at least a display section; wherein both of said housings are openably and closably coupled together so that said main operation section is covered with said second housing in a closed state and is exposed outside in an opened state, and said display section is exposed outside in both of the closed state and the opened state, an auxiliary operation section comprising a key or a plurality of keys provided on other surface than surfaces, which are opposed each other, of said both housings in the closed state, wherein part or all of said auxiliary operation section is inoperative at least in the opened state except the closed state.

Furthermore, the portable terminal unit according to claim 1, has: a state detecting section for detecting the opened/closed state of said first housing and said second housing; and a lock control section for rendering the part or all of said auxiliary operation section operative or inoperative based on a detection result from the state detecting section.

Furthermore, the all of said auxiliary operation section is operative by said lock control section when said state detecting section detects that both of said housings are in the closed state, and the part or all of said auxiliary operation section is inoperative by said lock control section when said detecting section detects that both of said housings are in other states than the closed state.

Furthermore, the part or all of said auxiliary operation section is inoperative by said lock control section when said state detecting section detects that both of said housings are in the opened state, and the all of said auxiliary operation section is operative by said lock control section when said state detecting section detects that both of said housings are in other states than the opened state.

Furthermore, said portable terminal unit is a mobile radiotelephone.

Furthermore, said portable terminal unit is a personal digital assistant.

The invention provides a portable terminal unit having: a first housing having at least a main operation section; a second housing subjected to be superimposed on said first housing so as to cover said main operation section; a coupling section for rotatablly coupling both of said housings that relatively rotate around an axis extending in a superimposed direction of said two housings; an auxiliary operation section comprising a key or a plurality of keys provided on other surface than surfaces, which are opposed each other, of said both housings in the closed state, wherein said key or said part or all of a plurality of keys is inoperative at least in a opened state except a closed state where the both of said housings relatively rotate 180° from the closed state.

Furthermore, the portable terminal unit has: a state detecting section for detecting the opened/closed state of said first housing and said second housing; and a lock control section for rendering said key or said part or all of a plurality of keys operative or inoperative based on a detection result from the state detecting section.

Furthermore, said key or said a plurality of keys is operative by said lock control section when said state detecting section detects that both of said housings are in the closed state, and said key or said part or all of a plurality of keys is inoperative by said lock control section when said detecting section detects that both of said housings are in other states than the closed state.

Furthermore, said key or said part or all of a plurality of keys is inoperative by said lock control section when said state detecting section detects that both of said housings are in the opened state, and said key or said a plurality of keys is operative by said lock control section when said state detecting section detects that both of said housings are in other states than the opened state.

Furthermore, the second housing has a display section on its surface faced in same direction as a direction of a surface having said main operation section.

Furthermore, said auxiliary operation section has a key provided on a side surface of said first housing and a key provided on a side surface of said second housing.

Furthermore, said portable terminal unit is a mobile radiotelephone.

Furthermore, said portable terminal unit is a personal digital assistant.

According to the portable terminal unit, the operation of the auxiliary operation section is inoperative in the case that the portable terminal unit is at least in the opened state. Hereby, when the user holds the housings with his hand in the opened state for a call, it is possible to prevent him from causing the erroneous operation by pressing down the auxiliary operation section erroneously. Further, the operation of the auxiliary operation section is inoperative in the case that the portable terminal unit is in other states than the closed state. Hereby, when the user opens or closes the housings with his hands, it is also possible to prevent him from causing the erroneous operation by pressing down the auxiliary operation section erroneously. Namely, occurrence of the erroneous operation can be eliminated, and operability can be improved.

### BRIEF DESCRIPTION OF THE DRAWINGS

FIGS. 1A and 1B are a diagram showing a closed state of a portable terminal unit according to a first embodiment of the invention;

FIGS. 2A and 2B are a diagram showing an opened state of the portable terminal unit according to the first embodiment of the invention;

FIGS. 3A and 3B are a side view showing the opened state of the portable terminal unit according to the first embodiment of the invention;

FIG. 4 is a block diagram of the portable terminal unit according to the first embodiment of the invention;

FIG. 5 is a flow chart for explaining an operation of the portable terminal unit according to the first embodiment of the invention; and

FIG. 6 is a flow chart for explaining an operation of a portable terminal unit according to a second embodiment of the invention.

### DETAILED DESCRIPTION OF THE PREFERRED EMBODIMENTS

Embodiments of the invention will be described below with reference to drawings.

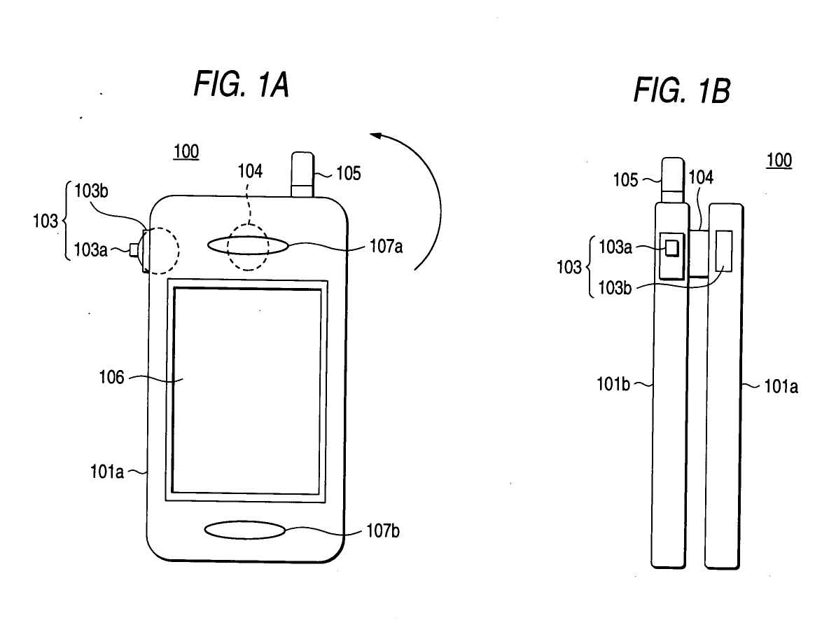

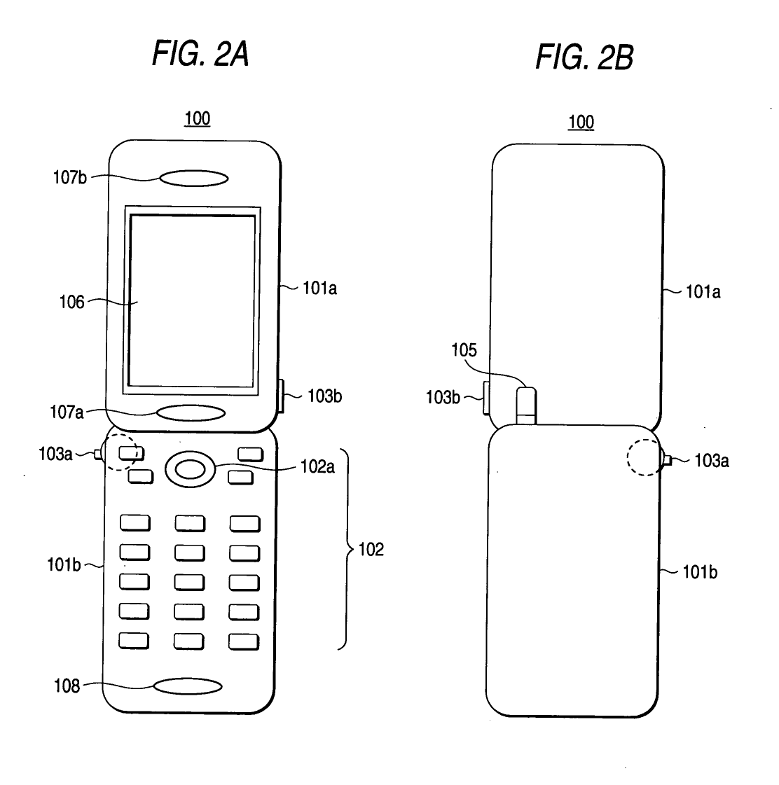

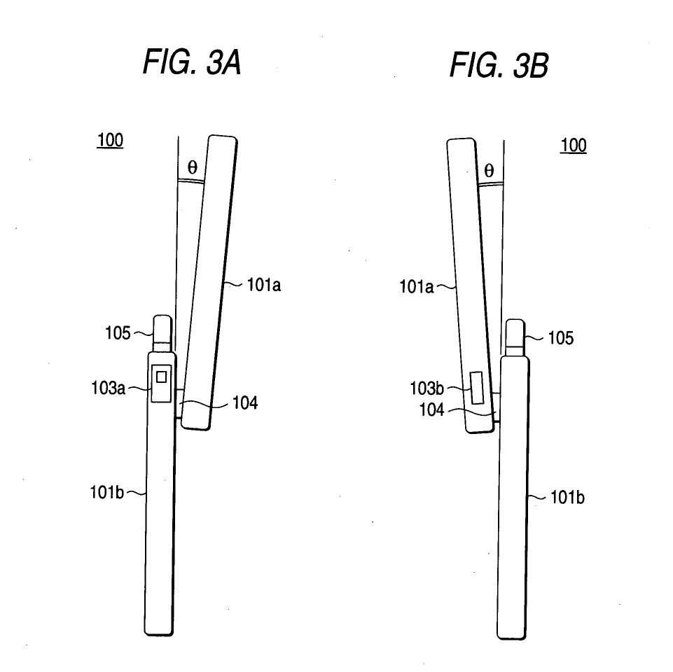

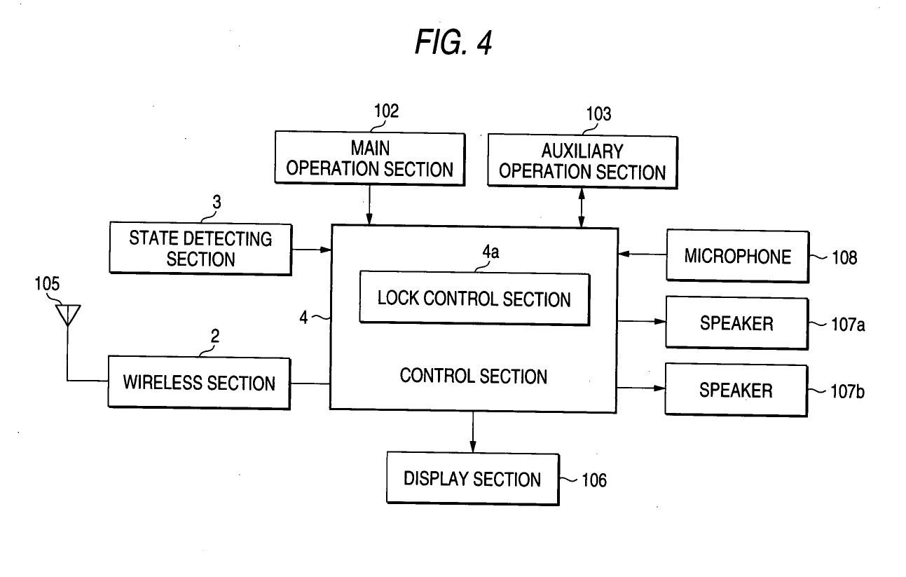

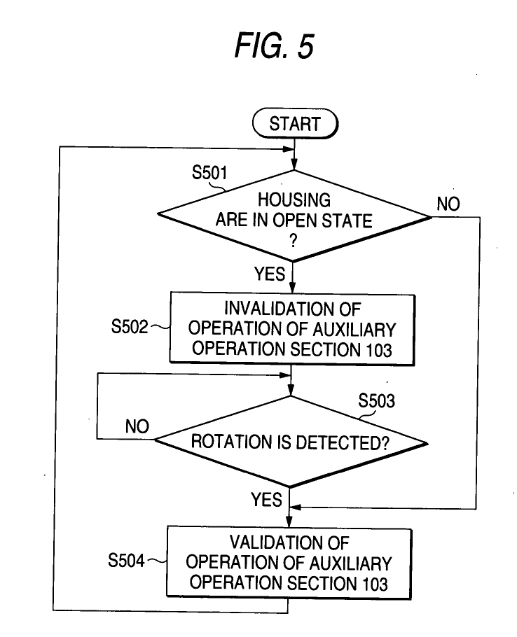

FIG. 1A is a front view showing a closed state of a portable terminal unit according to a first embodiment of the invention. FIG. 1B is a left side view showing the closed state of the portable terminal unit according to the first embodiment of the invention. FIG. 2A is a front view showing an opened state of the portable terminal unit according to the first embodiment of the invention. FIG. 2B is a back view showing the opened state of the portable terminal unit according to the first embodiment of the invention. FIG. 3A is a left side view showing the opened state of the portable terminal unit according to the first embodiment of the invention. FIG. 3B is a right side view showing the opened state of the portable terminal unit according to the first embodiment of the invention. FIG. 4 is a block diagram of the portable terminal unit according to the first embodiment of the invention. FIG. 5 is a flow chart for explaining an operation of the portable terminal unit according to the first embodiment of the invention.

A portable terminal unit 100 shown in FIGS. 1A to 3B is applied to a mobile telephone, in which reference numeral 101a is a display-side housing, reference numeral 101b is an operation-side housing, reference numeral 102 is a main operation section, reference numeral 102a is a plurality of keys in the main operation section 102, reference numeral 103 is an auxiliary operation section, reference numeral 103a is a three-directional lever key in the auxiliary operation section 103, reference numeral 103b is a side key in the auxiliary operation section 103, reference numeral 104 is a coupling section, reference numeral 105 is an antenna, reference numeral 106 is a display section, reference numerals 107a and 107b are speakers, and a reference numeral 108 is a microphone.

In this portable terminal unit 100, the display-side housing 101a and the operation-side housing 101b are openably and closably coupled by the coupling section 104. FIGS. 1A and 1B show the closed state in which the display-side housing 101a is put on the main operation section 102 of the operation-side housing 101b. When the display-side housing 101a is rotated about the coupling section 104 at an angle of 180° in the direction of an arrow from this closed state, the portable terminal unit becomes the opened state as shown in FIGS. 2A and 2B.

Further, in the opened state, the display section 106 and the two speakers 107a and 107b are provided on a surface, which is in the opposite side to the operation-side housing 101b, of the display-side housing 101a. The both speakers 107a and 107b are provided up and down of the display section 106, and the microphone 108 is provided on the surface having the main operation section 102, of the operation-side housing 101b.

Further, in the opened state, the auxiliary operation section 103 is provided on other surfaces than the surfaces opposed each other, of the both housings 101a and 101b, that is, on side surfaces of the both housings 101a and 101b in FIGS. 1A to 3B. This auxiliary operation section 103 has the three-directional lever 103a located on the side surface of the operation-side housing 101b, and the side key 103b located on the side surface of the display-side housing 101a.

Further, as shown in FIGS. 3A and 3B, in the opened state, the surface on the opposite side to the surface having the display section 106, of the display-side housing 101a is inclined to the surface having the main operation section 102, of the operation-side housing 101b at the predetermined angle θ (0<θ≦70°).

By the above configuration, the display section 106 is always exposed to the outside in both of the closed state and the opened state, and the main operation section 102 is exposed outside only in the opened state thereby to perform the operation.

The closed state means the state shown in FIGS. 1A and 1B in which the display-side housing 101a and the operation-side housing 101b are superimposed each other and the main operation section 102 of the operation-side housing 101b is covered with the display-side housing 101a. The opened state means the state shown in FIGS. 2A to 3B in which the display-side housing 101a moves in relation to the operation-side housing 101b and the main operation section 102 is exposed outside. Further, the invention can be applied not only to the portable terminal unit in which the display-side housing 101a turns in relation to the surface having the main operation section 102, of the operation-side housing 101b from the closed state shown in FIGS. 1A and 1B, but also to a portable terminal unit in which the display-side housing slides in relation to the surface having the main operation section 102, of the operation-side housing from the closed state shown in FIGS. 1A and 1B, whereby the main operation section is exposed outside, and a portable terminal unit in which the display-side housing can be turned in relation to the surface having the main operation section, of the operation-side housing about a parallel axis from the closed state shown in FIGS. 1A and 1B, and the display-side housing can be turned at an angle of 360° in relation to an axis vertical to the above axis, whereby the display section can be always exposed outside.

The display section 106 displays menu items on various functions provided for the portable terminal unit 100, an image file, e-mail contents received by the antenna 105, and various set screen.

The main operation section 102 has a key group on which letters and numerals are printed, and is used in order to perform operations corresponding to various functions such as call-making, call-ending, phone number-entering, mail letter-entering, and selection and setting of menu items displayed in the display section 106. A plurality of keys 102a in the main operation section 102 can especially perform vertical and horizontal operations, and a press operation, whereby the menu item displayed in the display section 106 is selected by the vertical and horizontal operations, and can be set by the press operation. Further, a transmission or reception mail display screen can be scrolled by the vertical operation.

The auxiliary operation section 103 has the three-directional lever key 103a and the side key 103b. The three-directional lever key 103a can be performed with vertical and horizontal operations and a press operation, whereby the menu item displayed in the display section 106 is selected by the vertical and horizontal operations, and can be set by the press operation. Further, the transmission or reception mail display screen can be scrolled by the vertical operation. Further, the side key 103b can be performed with the press operation, and by this press operation, the application can be started or the call during the call can be ended.

The speaker 107a and 107b enables the user to hear the voice of the other party in the call time. According to the open and closed states, the operations of the both speakers 107a and 107b are switched. Namely, in the closed state, the speaker 107b is not operated but only the speaker 107a is operated. In the opened state, the speaker 107a is not operated but only the speaker 107b is operated.

The microphone 108 collects the voice of the user in the call time. In the closed state, the microphone 108 is covered with the speaker 107b. However, by raising the sound-collecting rate of the microphone 108, the sound collection can be sufficiently performed.

Next, referring to the block diagram shown in FIG. 4, the inner configuration of the portable terminal unit 100 will be described. Reference numeral 4 is a control section which performs control of the whole of the portable terminal unit 100. Reference numeral 2 is a wireless section which delivers transmission and reception electronic waves between the antenna 105 and the control section 4. Reference numeral 3 is a state detecting section which (detects rotation of the coupling section 104 thereby to) detect whether the portable terminal unit 100 is in the closed state or in the opened state. Reference numeral 4a is a lock control section which renders the operation of the auxiliary operation section 103 inoperative or operative.

According to the portable terminal unit 100 of the invention, in the opened state, the main operation section 102 is exposed outside and the operation becomes possible. Therefore, the operation according to the contents displayed in the display section 106 can be performed by the main operation section 102. Further, in this state, a call using the speaker 107b and the microphone 108 is possible. In the closed state, the main operation section 102 is covered with the display-side housing 101a and the operation cannot be performed. Therefore, using the auxiliary operation section 103 in place of the main operation section 102, the operation according to the contents displayed in the display section 106 can be performed, and also a call using the speaker 107a and the microphone 108 is possible.

Next, the movement, relating to rendering the operation of the auxiliary operation section 103 of both of the three-directional lever key 103a and the side key 103b in the portable terminal unit 100 of the invention to be inoperative, will be described with reference to FIG. 5.

Firstly, at a step S501, whether the portable terminal unit 100 is in the opened state or in other states than the opened state is determined by state detecting section 3. When the portable terminal unit 100 is in the opened state, the state detecting section 3 detects that the portable terminal unit 100 is in the opened state, and transmits its signal to the control section 4. Then, the lock control section 4a shuts off electric connection of the auxiliary operation section 103 of both of the three-directional lever key 103a and the side key 103b thereby to render the operation of the auxiliary operation section 103 inoperative (S502) Thereafter, in the case that the turn of the coupling section 104 is not performed, the auxiliary operation section 103 is kept in the state where the operation is inoperative. However, when the turn of the coupling section 104 is performed, the state detecting section 3 detects that the portable terminal unit 100 is in other states than the opened state, and sends its signal to the control section 4 (S503). Then, the lock control section 4a performs the electric connection of the auxiliary operation section 103 thereby to render the operation operative (S504).

Further, at the step S501, when it is determined that the portable terminal unit 100 is in other states than the opened state, that is, the closed state or the turning state, the lock control section 4a performs the electric connection of the auxiliary operation section 103 thereby to render the operation operative (S504).

As described above, the operation of the auxiliary operation section 103 is operative in the closing state and in the turning state, and it is to be inoperative in the opened state. Hereby, when the user holds the operation-side housing 101b with his hand in the opened state in order to make or receive calls, even if he presses down the auxiliary operation section 103 erroneously, it is possible to prevent the erroneous operation from being caused.

Next, as a second embodiment, the operation of the auxiliary operation section 103 of both of the three-directional lever key 103a and the side key 103b may be operative only in the closed state, and it may be inoperative in the opened state and in the housing turning state.

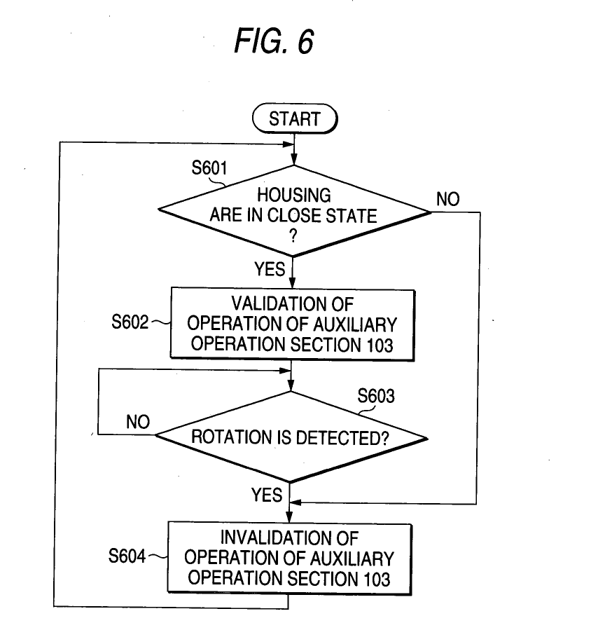

FIG. 6 is a flow chart for explaining a portable terminal unit 100 that is a second embodiment of the invention.

Firstly, at a step S601, whether the portable terminal unit 100 is in the closed state or in other states than the closed state is determined by a state detecting section 3. When the portable terminal unit 100 is in the closed state, a state detecting section 3 detects that the portable terminal unit 100 is in the closed state, and transmits its signal to a control section 4. Then, a lock control section 4a performs electric connection of an auxiliary operation section 103 thereby to render the operation operative (S602). Thereafter, in the case that a turn of a coupling section 104 is not performed, the auxiliary operation section 103 is kept in the state where the operation is operative. However, when the turn of the coupling section 104 is performed, the state detecting section 3 detects that the portable terminal unit 100 is in other states than the closed state, and sends its signal to the control section 4 (S603). Then, the lock control section 4a shuts off the electric connection of the auxiliary operation section 103 thereby to render the operation of the auxiliary operation section 3 inoperative (S604).

Further, at the step S601, when it is determined that the portable terminal unit 100 is in other states than the closed state, that is, the opened state or the turning state, the lock control section 4a shuts off the electric connection of the auxiliary operation section 103 thereby to render the operation of the auxiliary operation section 3 inoperative (S604).

As described above, the operation of the auxiliary operation section 103 is operative only in the closed state, and its operation is always inoperative in the opened state and in the turning state. Hereby, when the user holds an operation-side housing 101b with his hand in the opened state in order to make or receive calls, even if he presses down the auxiliary operation section 103 erroneously, it is possible to prevent the erroneous operation from being caused. Further, when the user operates to open or close the housings with his hand, it is possible to effectively prevent him from causing the erroneous operation by pressing down the auxiliary operation section 103 erroneously.

Further, in this portable terminal unit 100, by long press of the three-directional lever key 103a, both of the three-directional lever key 103a and the side key 103b in the closed state can be made inoperative. When the portable terminal unit 100 becomes an opened state where the three-directional lever key 103 is long pressed once, the three-directional lever key 103a is operative, and the side key 103b keeps inoperative. Further, when the three-directional lever key 103 is long pressed again, both of the three-directional lever key 103a and the side key 103b in the closed state can be made operative. Therefore, when both of the three-directional lever key 103a and the side key 103b are made inoperative in the state where the two housings 101a and 101b are closed when the portable terminal unit 100 is carried, it is possible to prevent the portable terminal unit 100 from causing the erroneous operation.

As described above, in these embodiments, the operations of both of the three-directional lever key 103a and the side key 103b are inoperative. However, the operation of either of them may be rendered inoperative and operative.

Further, in these embodiments, though the invention is applied to the mobile telephone, it may be applied to other portable terminal units such as a PDA and the like.

What is claimed is:

1. A portable terminal unit comprising:
a first housing having at least a main operation section;
a second housing having at least a display section;
wherein both of said housings are openably and closably coupled together so that said main operation section is covered with said second housing in a closed state and is exposed outside in an opened state, and said display section is exposed outside in both of the closed state and the opened state,
an auxiliary operation section comprising at least one key provided on other surface than surfaces, which are opposed each other, of said both housings in the closed state,
wherein said auxiliary operation section is inoperative at least in the opened state except the closed state.

2. The portable terminal unit according to claim 1, comprising:
a state detecting section for detecting the opened/closed state of said first housing and said second housing; and
a lock control section for rendering said auxiliary operation section operative or inoperative based on a detection result from the state detecting section.

3. The portable terminal unit according to claim 2,
wherein said auxiliary operation section is operative by said lock control section when said state detecting section detects that both of said housings are in the closed state, and
said auxiliary operation section is inoperative by said lock control section when said detecting section detects that both of said housings are in other states than the closed state.

4. The portable terminal unit according to claim 2,
wherein said auxiliary operation section is inoperative by said lock control section when said state detecting section detects that both of said housings are in the opened state, and
said auxiliary operation section is operative by said lock control section when said state detecting section detects that both of said housings are in other states than the opened state.

5. The portable terminal unit according to claim 1, wherein said portable terminal unit is a mobile radiotelephone.

6. The portable terminal unit according to claim 1, wherein said portable terminal unit is a personal digital assistant.

7. A portable terminal unit comprising:
a first housing having at least a main operation section;
a second housing subjected to be superimposed on said first housing so as to cover said main operation section;
a coupling section for rotatablly coupling both of said housings that relatively rotate around an axis extending in a superimposed direction of said two housings;
an auxiliary operation section comprising at least one key provided on other surface than surfaces, which are opposed each other, of said both housings in the closed state,
wherein said at least one key is inoperative at least in a opened state except a closed state where the both of said housings relatively rotate 180° from the closed state.

8. The portable terminal unit according to claim 7, comprising:
a state detecting section for detecting the opened/closed state of said first housing and said second housing; and
a lock control section for rendering said at least one key operative or inoperative based on a detection result from the state detecting section.

9. The portable terminal unit according to claim 8,
wherein said key or said at least one key is operative by said lock control section when said state detecting section detects that both of said housings are in the closed state, and
said key or said at least one key is inoperative by said lock control section when said detecting section detects that both of said housings are in other states than the closed state.

10. The portable terminal unit according to claim 8,
wherein said at least one key is inoperative by said lock control section when said state detecting section detects that both of said housings are in the opened state, and
said at least one key is operative by said lock control section when said state detecting section detects that both of said housings are in other states than the opened state.

11. The portable terminal unit according to claim 7,
wherein the second housing has a display section on its surface faced in same direction as a direction of a surface having said main operation section.

12. The portable terminal unit according to claim 7,
wherein said auxiliary operation section has a first key provided on a side surface of said first housing and a second key provided on a side surface of said second housing.

13. The portable terminal unit according to claim 7, wherein said portable terminal unit is a mobile radiotelephone.

14. The portable terminal unit according to claim 7, wherein said portable terminal unit is a personal digital assistant.
